(19) United States
(12) Patent Application Publication
(10) Pub. No.: US 2014/0349726 A1
(43) Pub. Date: Nov. 27, 2014

(54) PLAYER-INDUCED EFFECTS ON E-TABLE PLAYFIELD

(71) Applicant: WMS Gaming, Inc., Waukegan, IL (US)

(72) Inventors: Dale R. Buchholz, Palatine, IL (US); Mary M. Burke, Somonauk, IL (US); Brian L. Yarger, Arlington Heights, IL (US); Anthony J. Baerlocher, Henderson, NV (US); Jesse M. Smith, Chicago, IL (US); Matthew J. Ward, Northbrook, IL (US)

(73) Assignee: WMS Gaming, Inc., Waukegan, IL (US)

(21) Appl. No.: 14/280,905

(22) Filed: May 19, 2014

Related U.S. Application Data
(60) Provisional application No. 61/825,896, filed on May 21, 2013.

(51) Int. Cl. G07F 17/32

(52) U.S. Cl. CPC G07F 17/3244; G07F 17/3293; G07F 17/322
USPC 463/11; 463/25

(57) ABSTRACT

A method for presenting the appearance of altered game outcome is described herein. In some embodiments, the operations can include presenting, by an electronic wagering game table, a wagering game including a game piece. The operations can also include determining a result for the wagering game. The operations can also include receiving first player input to move the game piece to reveal the result. The operations can also include presenting, on a display device, movement of the game piece. The operations can also include receiving, by the electronic wagering game table, second player input to alter the movement of the game piece, wherein alteration of the movement of the game piece appears to modify the result for the wagering game. The operations can also include presenting, in response to the second player input, altered movement of the game piece and the result for the wagering game.

### RELATED APPLICATIONS

This application claims the priority benefit of U.S. Provisional Application Ser. No. 61/825,896 filed May 21, 2013.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2014, WMS Gaming, Inc.

### FIELD

Embodiments of the inventive subject matter relate generally to wagering game systems, and more particularly to wagering game systems including electronic wagering game tables.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### BRIEF DESCRIPTION OF THE FIGURES

Embodiments of the invention are illustrated in the Figures of the accompanying drawings in which:

FIG. 1 is a perspective drawing of an example electronic wagering game table (“e-table”) 108 presenting an electronic craps game, according to some embodiments of the inventive subject matter.

FIG. 2 is a perspective drawing of a roulette e-table 202, according to some embodiments of the inventive subject matter.

FIG. 3 is a perspective drawing of a blackjack e-table 302 presenting an electronic blackjack game, according to some embodiments of the inventive subject matter.

FIG. 4 is a flow diagram illustrating example operations for an e-table presenting an effect to give the impression of an altered outcome in a wagering game, according to some embodiments of the inventive subject matter.

FIG. 5 depicts a block diagram illustrating a wagering game machine architecture, according to some example embodiments.

FIG. 6 is a block diagram illustrating a wagering game network 600, according to example embodiments of the invention.

FIG. 7 depicts a perspective view of a wagering game machine, according to some example embodiments.

FIG. 8 depicts an image of a base-game screen for a wagering game machine, according to some example embodiments.

### DESCRIPTION OF THE EMBODIMENTS

### Introduction

This section provides an introduction to some embodiments of the invention.

Some players may feel more engaged in wagering games if they believe they can alter game results, as the wagering games are being played. For example, with e-table dice games, players may feel more engaged if they believe that they can influence results of dice rolls, such as after the dice leave a shooter's hand. Therefore, to increase feelings of engagement and entertainment, some embodiments present audio and visual effects that give players an impression they have influenced wagering game results, where those effects do not actually influence wagering game results. As another example, for a community-style video craps games, some embodiments enable players to “nudge” the e-table to exert a perceived influence over dice rolling and game results. Such a nudge may alter movement of the rolling dice (e.g., via animation), but will not affect the actual results. Embodiments provide some players with more entertaining gaming experiences by giving them a feeling that they can influence wagering game results. These and other embodiments are described in greater detail below.

### Electronic Table Games

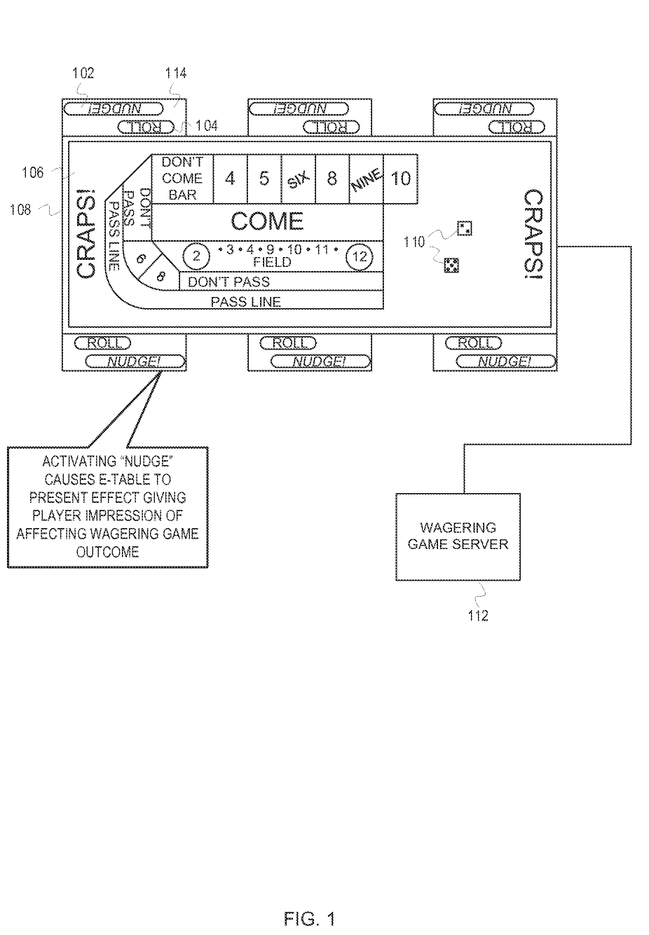

FIG. 1 is a perspective drawing of an example electronic wagering game table (“e-table”) 108 presenting a craps game, according to some embodiments of the inventive subject matter. E-tables are manufactured in various shapes, forms, and sizes. Most e-tables are used to play community wagering games, such as dice games, card games, etc. Further, some e-tables have a plurality of individual wagering stations from which players can wager on the community wagering game. The community wagering game can be a virtual game (e.g., video blackjack), a physical game (i.e., a game played with physical game pieces, such as roulette), or a game that has a combination of both virtual and physical elements. Some e-tables presenting virtual community wagering games utilize one large display device, such as a liquid crystal display (LCD). An e-table having one large display device is depicted in FIG. 1.

As shown in FIG. 1, an e-table 108 includes one large common display device 106 presenting a craps wagering game. The e-table also includes a plurality of wagering stations 114. Players can partake in the community wagering games via the wagering stations 114. The player designated as the shooter can begin the craps wagering game by rolling the virtual dice 110 using a “roll” button 104 at the wagering station 114. When the shooter presses the “roll” button 104, the e-table communicates with a wagering game server 112 to determine the outcome of the craps wagering game. In some embodiments, the e-table itself determines the outcome.

In some embodiments, the e-table 108 can receive player input that causes the e-table 108 to present an effect giving players an impression that they have affected the craps game outcome. For example, some embodiments receive such player input via a “nudge” button 102. In some embodiments, when a player presses the “nudge” button 102 while the virtual dice 110 are “rolling” on the e-table 108, the display device 106 presents graphical effects that give a visual impression that the e-table 108 was physically nudged. In other words, the image of the craps table presented on the display device 106 can shake or otherwise move, giving the impression that the e-table 108 was physically nudged by a player. Although it appears that the player has affected the outcome of the craps wagering game by “nudging” the e-table, the outcome of the craps wagering game was predetermined at the wagering game server 112 (or e-table itself), and the predetermined outcome is presented on the display device 106. Additionally, in some embodiments, players can attempt to affect the outcome of the craps games in various ways. For example, players can provide input to digitally tilt the craps table or play field, alter the coefficient of kinetic friction of the playfield to decrease/increase the speed at which the dice travel across the playfield, cause the dice to roll backwards, cause the dice to stop abruptly, etc. Therefore, some embodiments present visual and other effects (e.g., audio content) that give players an impression they have influenced wagering game results, where those effects do not actually influence wagering game results.

In some embodiments, e-tables can present wagering games that are completely virtual. In other words, the wagering game can be presented entirely on one or more display devices (e.g., LCD screens, light emitting diode (LED) screens, etc.). In some embodiments, some of the wagering game content is presented on one or more community display devices, while the wagering game content that is player-specific is presented on individual display devices. For example, in a virtual poker game, the community display can present animation depicting dealing and each player's bet, while individual display devices can present each player's hand. In other embodiments, the entirety of the wagering game content can be presented on a community display device. For example, in a virtual craps game, the play table, player bets, dice, etc. can all be presented on a single community display. In such embodiments, players can place wagers, initiate gameplay, etc. from individual wagering stations. However, in some embodiments, the wagering game may be partially physical and partially virtual, or entirely physical. For example, in a roulette game, a portion of the wagering game can be physical and a portion of the wagering game can be virtual. For example, the roulette wheel and ball can be physical (i.e., the e-table houses a standard roulette wheel and ball), while players can indicate bets virtually at wagering stations. Alternatively, the entire roulette game can be physical.

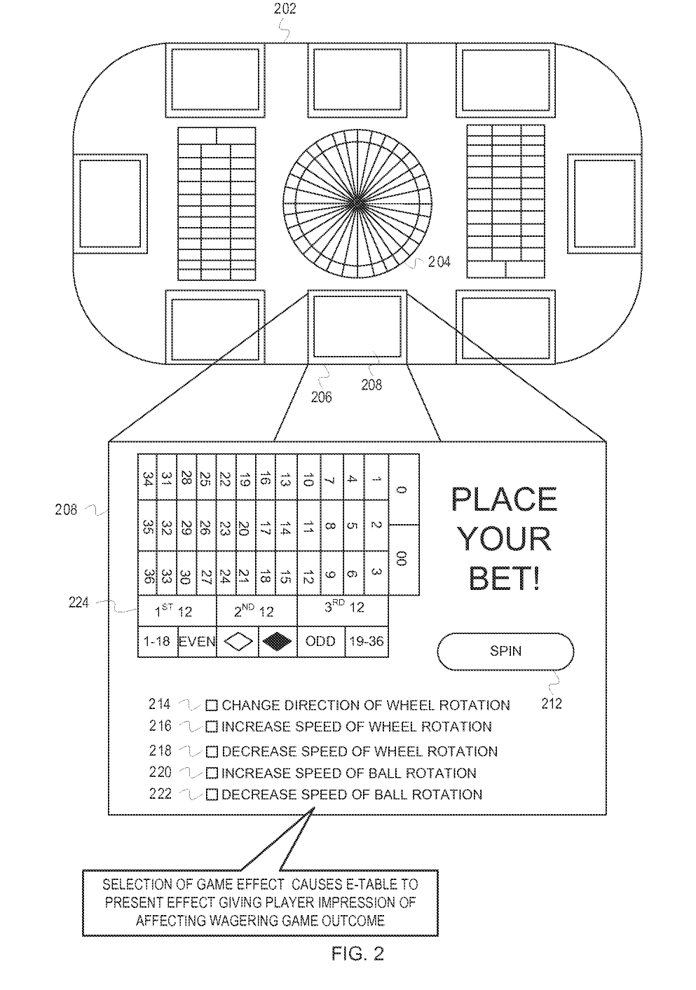

Although FIG. 1 describes e-tables having a single large common display device presenting a virtual community wagering game, FIG. 2 describes e-tables having physical wagering games and a plurality of virtual wagering stations.

FIG. 2 is a perspective drawing of a roulette e-table 202, according to some embodiments of the inventive subject matter. As depicted in FIG. 2, a physical roulette wheel 204 is located near the center of the e-table 202. During gameplay, the roulette wheel 204 spins while a ball traverses a balltrack in a direction opposite to the rotation of the roulette wheel 204, as is typical in many roulette games. Additionally, the e-table 202 contains a plurality of wagering stations 206 from which players can play the roulette game. Each wagering station has an individual display device 208. FIG. 2 shows an expanded view of the display device 208. Display device 208 is presenting a roulette playing field 224, a spin button 212, and wagering game effect options 214-222. When the player presses the spin button 212, the roulette wheel 204 and the ball rotate. Again, players may feel more engaged in the wagering game if they believe that they can affect the outcome of the wagering game. Accordingly, the e-table 202 enables players to choose from a plurality of wagering game effect options 214-222. For example, players can change the direction of the roulette wheel's rotation 214, increase the speed with which the roulette wheel 204 rotates 216, decrease the speed with which the roulette wheel 204 rotates 218, increase the speed with which the ball traverses the balltrack 220, decrease the speed with which the ball traverses the balltrack 222, and hop the ball. Such game effects allow the player to feel they can affect the outcome of the wagering game while still maintaining the integrity of the outcome of the wagering game. For example, if the player chooses to change the direction of the roulette wheel 204 rotation, the random nature of the outcome of the wagering game is maintained. However, changing the direction of the roulette wheel 204 rotation may allow the player to feel that they have affected the outcome of the wagering game. In some embodiments, the magnitude of the player's interaction with the wagering game is limited to maintain the integrity of the outcome of the wagering game. For example, although the player may choose to decrease the speed with which the ball traverses the balltrack, there can be a minimum velocity with which the ball will initially travel, regardless of the player input. Likewise, there can be a maximum speed with which the ball will initially travel, regardless of the player input. In other words, in some embodiments, the player is only able to alter the speed with which the ball traverses the balltrack within a minimum and maximum value. However, the player's alterations will not affect the randomness of the wagering game results. The game variations can be implemented with physical implementations (e.g., traditional roulette table with roulette wheel) and with virtual implementations (e.g., video versions of games where effects are implemented via visual and auditory media).

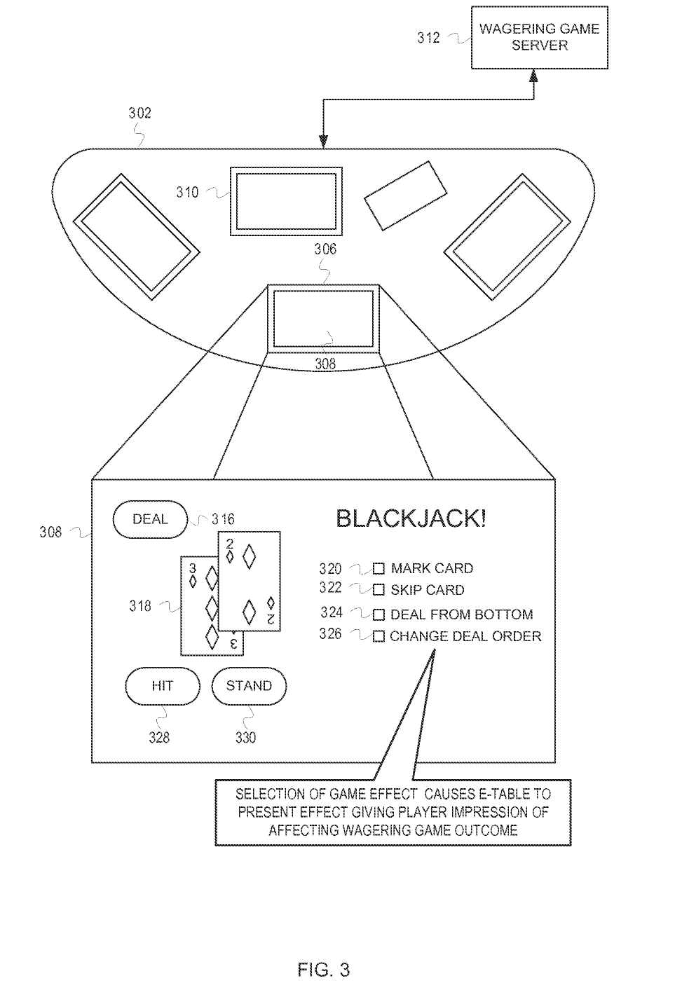

While FIG. 2 describes e-tables having a physical wagering game and a plurality of virtual wagering stations, FIG. 3 describes e-tables having a common virtual display as well as a plurality of virtual wagering stations.

FIG. 3 is a perspective drawing of a blackjack e-table 302 presenting an electronic blackjack game, according to some embodiments of the inventive subject matter. The e-table 302 includes wagering stations 306, and a dealer station 310. Players can play blackjack at the wagering stations 306 using the display device 308 at the wagering station. FIG. 3 shows an expanded image of the display device 308. As shown, the display device 308 includes a touchscreen device including a deal button 316, a hit button 328, and a stand button 330. When the player presses the deal button, the system deals electronic playing cards 318, as in many blackjack games. The wagering game server 312 determines which card will be dealt next, and consequently, the outcome of the blackjack game.

Some players may be more engaged in the blackjack game if they believe that they can affect the outcome. Accordingly, some embodiments enable players to choose from a plurality of wagering game effect options 320-326. For example, the player can virtually mark cards 320, skip cards in the deck during dealing 322, choose to deal from the bottom of the deck as opposed to from the top 324, and change the order in which players are dealt cards 326. In some instances, such as card marking, a player's interaction can give the player a slight advantage. The e-table can account for any advantages in the game's payout math. In other embodiments, because the wagering game server 312 determines the outcome of the blackjack game, the wagering game effect options 320-326 do not actually affect wagering game outcome, but rather they affect presentation of the wagering game. For example, if the player chooses to deal cards from the bottom of the deck, an animation may show the cards being dealt from the bottom of the deck. However, because the specific card to be dealt is determined by the wagering game server 312, only animations are altered, not the actual cards that are dealt. Similarly, for the other wagering game effects, the outcome of the wagering game is not in fact affected, but only appears to be affected.

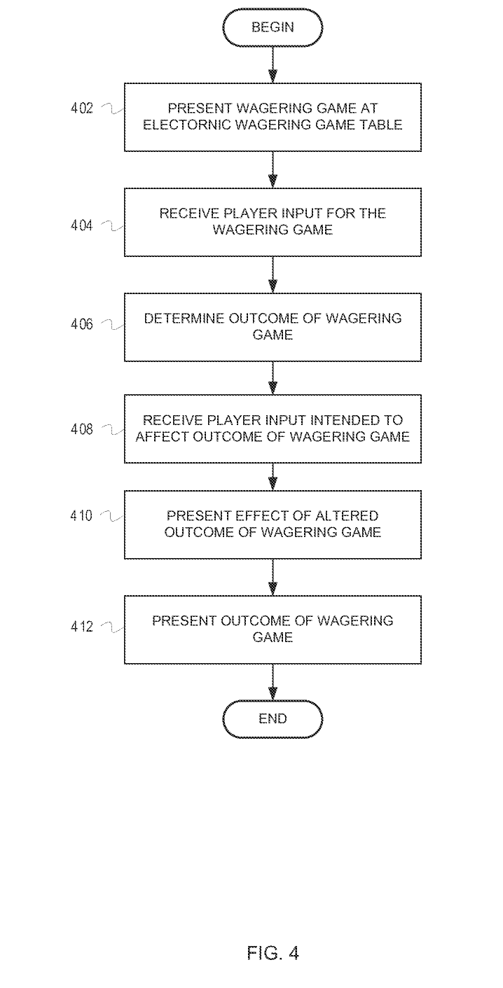

While FIGS. 1-3 describe various examples of e-tables and possible wagering games that can be played on the e-tables, FIG. 4 describes example operations of an e-table to present an effect to give the impression of an altered game outcome.

### Example Operations

FIG. 4 is a flow diagram illustrating example operations for an e-table presenting an effect to give the impression of an altered outcome in a wagering game, according to some embodiments of the inventive subject matter. The flow begins at block 402.

At block 402, the e-table presents a wagering game. The wagering game can be any of a variety of wagering games suitable for presentation on an e-table, such as blackjack, poker, roulette, baccarat, Texas Hold 'Em, etc. The flow continues at block 404.

At block 404, the e-table receives player input for the wagering game. For example, in a virtual craps game, the e-table can receive player input to roll the dice. For a card game, the e-table can receive player input to deal the cards. The flow continues at block 406.

At block 406, the e-table determines the outcome of the wagering game. For example, in a virtual craps game, the e-table can use a random number generator (or other suitable technology) to determine the outcome of the virtual craps game. It is not necessary that the e-table itself determine the outcome of the wagering game. For example, in some embodiments, other components (e.g., the wagering game server) can determine the outcome of the wagering game and report the outcome of the wagering game to the e-table. The flow continues at block 408.

At block 408, the e-table receives player input related to affecting the outcome of the wagering game. The player input can be received via any suitable means. For example, the e-table may contain hard or soft buttons which a player can activate to achieve the desired result. For example, in a virtual craps game, the e-table may contain a “nudge” button which the player can activate. Additionally, the e-table can include sensors to detect input by the player. For example, the e-table can include pressure sensors, which can detect a player pushing against the e-table. The e-table can also include sensors that detect motion of the e-table. For example, the e-table can include an accelerometer or other sensor than can detect player movement of the e-table. In some embodiments, the e-table can have motion or other optical sensors. In such embodiments, the e-table can detect player hand gestures. Additionally, the e-table can present a menu on a display device from which players can select a game effect. For example, in some embodiments, in a roulette game, a player can select from among game effect menu options a game effect to reverse the direction in which the roulette wheel rotates. In some embodiments, only one player at a time can provide input intended to affect the outcome of the wagering game. For example, during a craps game, only the shooter can provide player input intended to affect the outcome of the wagering game. Alternatively, the player able to provide the input may be randomly selected (e.g., for each round), or the player that is able to provide the input may be the player with the highest wager, longest playtime, etc. The flow continues at block 410.

At block 410, the e-table presents the effect of an altered outcome of the wagering game. In other words, when the e-table receives player input related to affecting the outcome of the wagering game, the e-table responds by presenting the appearance (e.g., one or more visual effects, audio effects, combination of audio and visual effects, etc.) that the outcome of the wagering game has been altered by the player input. For example, in a virtual craps game having a large community display device presenting the playing field, when a player nudges the e-table, the e-table's display device can cause the image of the playing field to move or shake, giving the player the impression that their input has affected the playing field, and by extension, the way the dice will roll, thus affecting the outcome of the wagering game. The flow continues at block 412.

At block 412, the e-table presents the outcome of the wagering game. As previously discussed, the outcome of the wagering game may be predetermined, such as for fully or partially virtual wagering games. Consequently, although it appears to affect game outcome, the game effect utilized by the player has no bearing on the outcome of the wagering game. In physical embodiments, or embodiments not suitable to predetermined outcomes, the game effect utilized by the player may alter gameplay, but ultimately does not change the random nature of the game outcome (e.g., the game effect does not change odds of winning)

Although examples refer community wagering games and e-tables presenting effects giving players the impression that they have affected game outcomes, in some embodiments any wagering game machine (including single player wagering game machines) can present effects that give a player the impression that they have affected the game outcome. For example, a player playing a single-player video poker game can select game effects that will appear to alter the outcome of the wagering game. The player can choose to deal from the bottom of the deck, “burn” greater or fewer cards in a “Texas Hold 'Em” game, etc. In other words, players can provide input intended to affect the outcome of the wagering game on any wagering game machine.

Although examples refer to presenting either virtual or physical effects that give the impression that the outcome of the wagering game is affected, in some embodiments both virtual and physical game effects can be incorporated in the same e-table. For example, in a wagering game incorporating both virtual game elements and physical game elements, both virtual and physical effects can be presented. Additionally, both virtual and physical effects do not have to be presented in unison. For example, in a wagering game incorporating both virtual game elements at physical game elements, dependent on the player input, either virtual effects or physical effects can be presented.

Some examples (above) refer to receiving player input for the wagering game, determining an outcome of the wagering game, receiving player input intended to affect the outcome of the wagering game, then presenting the effect of an altered outcome of the wagering game. However some embodiments can perform such operations in any order suitable to the specific wagering game, e-table composition, etc. For example, in a roulette game, the e-table can receive player input intended to affect the outcome of the game before receiving player input for the wagering game. In other words, the player can choose to change the speed with which the ball traverses the balltrack before the ball is released. Additionally, in some embodiments, all of the operations depicted in FIG. 4 may not be necessary. For example, in a roulette game, the outcome of the wagering game need not be predetermined. Rather the outcome of the roulette game is determined based on randomness associated with physical forces on the ball.

Some examples (above) refer to receiving player input related to affecting the wagering game from a single player. However, in some embodiments, more than one player can provide player input related to affecting the outcome of the wagering game. For example, two players can provide player input related to affecting the outcome of the wagering game. In some embodiments, the e-table will present an effect of altered outcome of the wagering game corresponding to only one of the player inputs. In other embodiments, the e-table may aggregate the player inputs and present one effect of altered game outcome corresponding to the aggregated player inputs. For example, if each player “nudges” the e-table from opposite sides, the two player inputs may cancel each other out. Alternatively, player inputs may be combined to increase the magnitude of the effect presented by the e-table.

Some examples (above) refer to e-tables and wagering game machines. However, in some embodiments, players can provide player input related to affecting the outcome of the wagering game on a mobile device. In some embodiments, the mobile device can present the wagering game. For example, a mobile device can present a picking game where there are several round objects on a surface having holes. The goal of the game is to manipulate the playfield to cause one of the objects to fall into a hole. Sensors in the mobile device can detect player movement of the mobile device in an effort to achieve the desired outcome. Additionally, a player can manipulate the playfield by touching the playfield in a specific spot. Although the player can control which object falls into a hole, the award won can be independent of which object actually falls into the hole. In some embodiments, a mobile device can be used in concert with an e-table or wagering game machine. For example, the mobile device can present a portion of the wagering game. Additionally, in some embodiments, a player can interact with the portion of the wagering game presented on a community display via their mobile device. For example, a player can move wagering game objects from their mobile device onto the playfield presented on the community display device in an attempt to affect the outcome of the wagering game.

Some examples (above) refer to buttons and sensors detecting player input related to affecting the outcome of the wagering game. However, in some embodiments, players can provide input via joysticks, or other suitable input devices. For example, in a roulette game, a player may be able to manipulate the roulette wheel via a joystick. In some embodiments, player movement of the joystick about the z-axis can cause the roulette wheel to move about the z-axis, the movement of the roulette wheel mimicking that of the joystick.

Multiple player inputs can be combined or chosen from in any suitable manner. For example, the e-table can present an effect associated with a single player input from among a plurality of player inputs. The e-table can determine which player input induced effect to present based on amount of each players' wager. For example, the player input associated with the player wagering the greatest amount can be chosen. Alternatively, player inputs can be combined relative to the amount of each player's wager. For example, the player input from a player wagering $100 can be reflected in a magnitude twice that of the player input from a player wagering $50. In some embodiments, an effect can be chosen based on the player input from a player that has the least/greatest effect on the wagering game object or e-table.

Although examples refer to game effects being available to all players, in some embodiments, different players may have access to differing game effects. For example, in some embodiments, game effects are earned by playing wagering games and the game effects are linked to a player's player account. Alternatively, game effects may be accessible to players on a random, arbitrary, etc. basis.

Although embodiments refer to community games and player input related to affecting the community game for all players playing the wagering game, in some embodiments, each player input will relate only to their own wagering game. For example, each player may utilize a different game effect. Each player will realize an effect presented by the e-table consistent with their player input.

In some embodiments, results of the wagering game can trigger bonus games. In such embodiments, players can provide input that appears to affect gameplay in the bonus game, similar to the embodiments described above. In some embodiments, players can only provide input that appears to affect the bonus game and not the base wagering game. In other embodiments, players can provide input that appears to affect only the base wagering game or both the base wagering game and the bonus game.

Although FIGS. 1-4 describes some embodiments, the following sections describe many other features and embodiments.

### Operating Environment

This section describes an example operating environment and presents structural aspects of some embodiments. This section includes discussion about wagering game machine architectures and wagering game networks.

### Wagering Game Machine Architectures

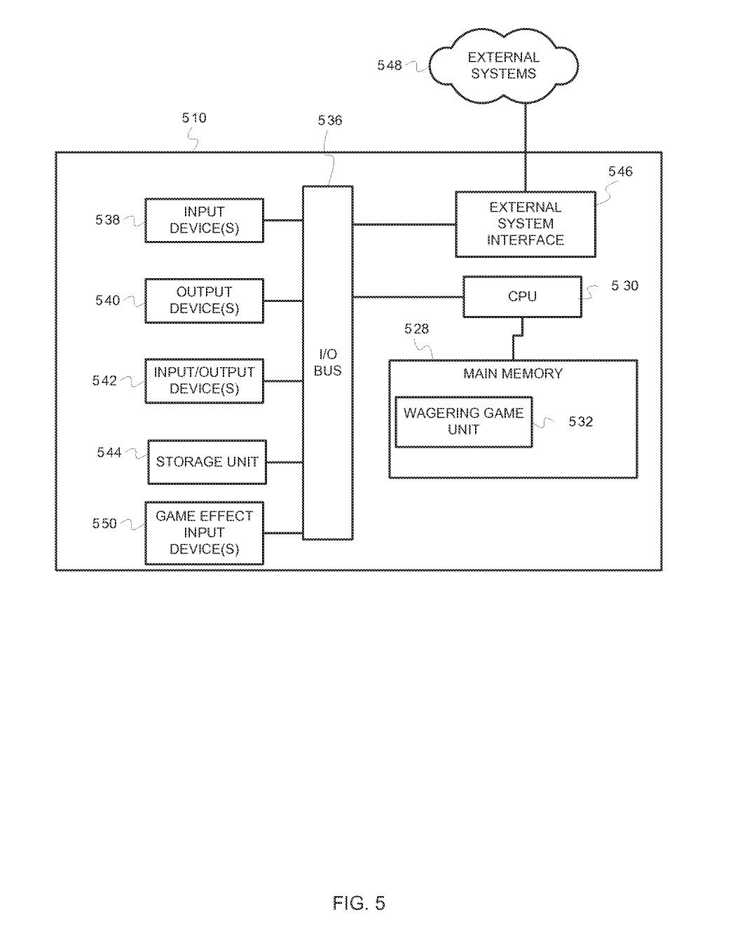

FIG. 5 depicts a block diagram illustrating a wagering game machine architecture, according to some example embodiments. The gaming terminal 510 includes a central processing unit (CPU) 530 connected to a main memory 528. The CPU 530 may include any suitable processor(s), such as those made by Intel and AMD. By way of example, the CPU 530 includes a plurality of microprocessors including a master processor, a slave processor, and a secondary or parallel processor. CPU 530, as used herein, comprises any combination of hardware, software, or firmware disposed in or outside of the gaming terminal 510 that is configured to communicate with or control the transfer of data between the gaming terminal 510 and a bus, another computer, processor, device, service, or network. The CPU 530 comprises one or more controllers or processors and such one or more controllers or processors need not be disposed proximal to one another and may be located in different devices or in different locations. The CPU 530 is operable to execute all of the various gaming methods and other processes disclosed herein. The main memory 528 includes a wagering game unit 532. In one embodiment, the wagering game unit 532 may present wagering games, such as video poker, video black jack, video slots, video lottery, etc., in whole or part.

The CPU 530 is also connected to an input/output (I/O) bus 536, which can include any suitable bus technologies, such as an AGTL+ frontside bus and a PCI backside bus. The I/O bus 536 is connected to various input devices 538, output devices 540, and input/output devices 542. The I/O bus 536 is also connected to storage unit 544 and external system interface 546, which is connected to external system(s) 548 (e.g., wagering game networks). Additionally, the I/O bus 536 is connected to game effect input device(s) 550. The game effect input device(s) 550 can be any device suitable for receiving input, such as hard buttons, soft buttons, sensors, etc.

The external system 548 includes, in various aspects, a gaming network, other gaming terminals, a gaming server, a remote controller, communications hardware, or a variety of other interfaced systems or components, in any combination. In yet other aspects, the external system 548 may comprise a player's portable electronic device (e.g., cellular phone, electronic wallet, etc.) and the external system interface 546 is configured to facilitate wireless communication and data transfer between the portable electronic device and the CPU 530, such as by a near-field communication path operating via magnetic-field induction or a frequency-hopping spread spectrum RF signals (e.g., Bluetooth, etc.).

The gaming terminal 510 optionally communicates with the external system 548 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 510 (“thick client” gaming terminal), the external system 548 (“thin client” gaming terminal), or are distributed there between in any suitable manner (“intermediate client” gaming terminal).

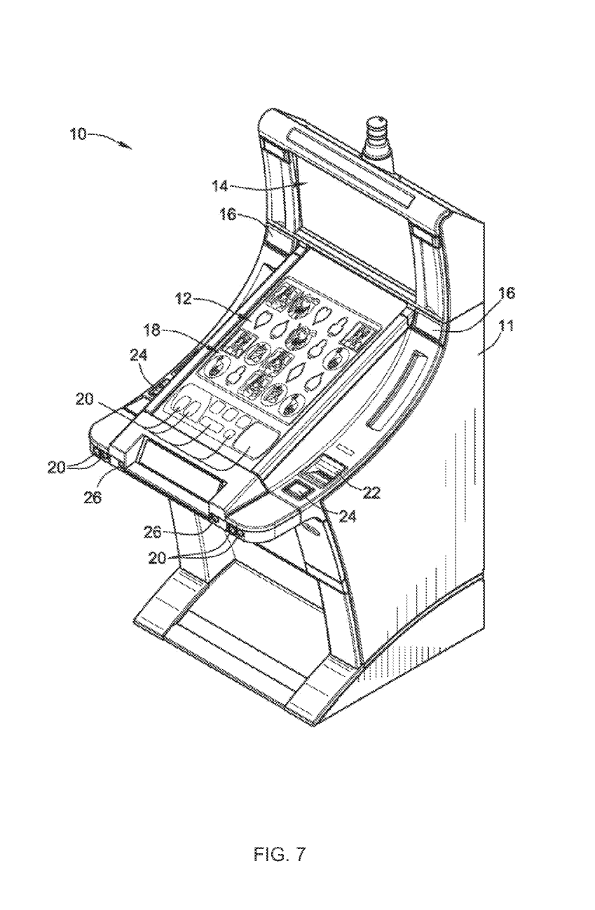

The gaming terminal 510 may include additional peripheral devices or more than one of each component shown in FIG. 7. Any component of the gaming terminal architecture may include hardware, firmware, or tangible machine-readable storage devices including instructions for performing the operations described herein. Machine-readable storage devices can include semiconductor memory devices (RAM, Flash media, etc.), magnetic storages devices (disk drives), optical media (DVDs), etc.

While FIG. 5 describes an example wagering game machine architecture, this section continues with a discussion wagering game networks.

### Wagering Game Networks

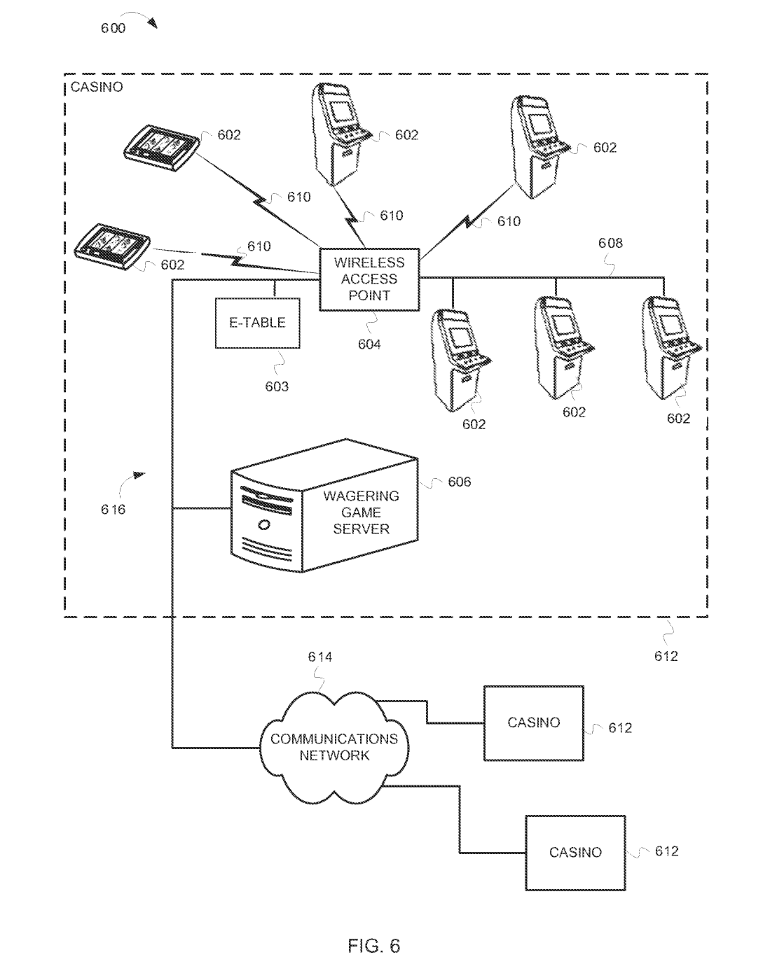

FIG. 6 is a block diagram illustrating a wagering game network 600, according to example embodiments of the invention. As shown in FIG. 6, the wagering game network 600 includes a plurality of casinos 612 connected to a communications network 614.

Each casino 612 includes a local area network 616, which includes an access point 604, a wagering game server 606, and wagering game machines 602 and e-table 603. The access point 604 provides wireless communication links 610 and wired communication links 608. The wired and wireless communication links can employ any suitable connection technology, such as Bluetooth, 802.11, Ethernet, public switched telephone networks, SONET, etc. In some embodiments, the wagering game server 606 can serve wagering games and distribute content to devices located in other casinos 612 or at other locations on the communications network 614.

The wagering game machines 602 described herein can take any suitable form, such as floor standing models, handheld mobile units, bartop models, workstation-type console models, etc. The e-table 603 can take any suitable form, such as a blackjack table, roulette table, etc. Further, the wagering game machines 602 and e-table 603 can be primarily dedicated for use in conducting wagering games, or can include non-dedicated devices, such as mobile phones, personal digital assistants, personal computers, etc. In one embodiment, the wagering game network 600 can include other network devices, such as accounting servers, wide area progressive servers, player tracking servers, and/or other devices suitable for use in connection with embodiments of the invention.

In some embodiments, wagering game machines 602, e-table 603, and wagering game servers 606 work together such that a wagering game machine 602 (and e-table 603) can be operated as a thin, thick, or intermediate client. For example, one or more elements of game play may be controlled by the wagering game machine 602 or e-table 603 (client) or the wagering game server 606 (server). Game play elements can include executable game code, lookup tables, configuration files, game outcome, audio or visual representations of the game, game assets or the like. In a thin-client example, the wagering game server 606 can perform functions such as determining game outcome or managing assets, while the wagering game machine 602 or e-table 603 can present a graphical representation of such outcome or asset modification to the user (e.g., player). In a thick-client example, the wagering game machines 602 or e-table 603 can determine game outcomes and communicate the outcomes to the wagering game server 606 for recording or managing a player's account.

In some embodiments, either the wagering game machines 602 or e-table 603 (client) or the wagering game server 606 can provide functionality that is not directly related to game play. For example, account transactions and account rules may be managed centrally (e.g., by the wagering game server 606) or locally (e.g., by the wagering game machine 602 or e-table 603). Other functionality not directly related to game play may include power management, presentation of advertising, software or firmware updates, system quality or security checks, etc.

Any of the wagering game network components (e.g., the wagering game machines 602 or e-table 603) can include hardware and machine-readable media including instructions for performing the operations described herein.

### Example Wagering Game Machines

FIG. 7 depicts a perspective view of a wagering game machine, according to some example embodiments. Referring to FIG. 7, there is shown a gaming terminal 10 similar to those used in gaming establishments, such as casinos. With regard to some embodiments of the present invention, the gaming terminal 10 may be any type of gaming terminal and may have varying structures and methods of operation. For example, in some aspects, the gaming terminal 10 is an electromechanical gaming terminal configured to play mechanical slots, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models as shown, handheld mobile units, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433 and Patent Application Publication Nos. US2010/0062196 and US2010/0234099, which are incorporated herein by reference in their entireties.

The gaming terminal 10 illustrated in FIG. 7 comprises a cabinet 11 that may house various input devices, output devices, and input/output devices. By way of example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming terminal 10. The gaming terminal 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

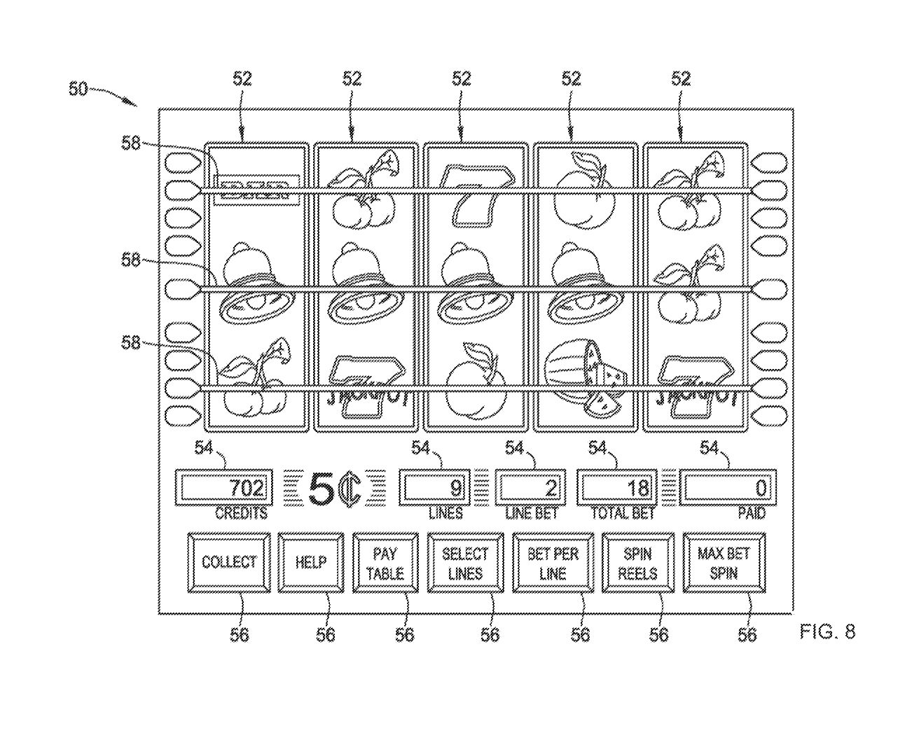

FIG. 8 depicts an image of a base-game screen for a wagering game machine, according to some example embodiments. Referring to FIGS. 7 and 8, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20. The CPU operate(s) to execute a wagering game program causing the primary display area 12 or the secondary display area 14 to display the wagering game.

In response to receiving a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media, the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A method comprising:
presenting, by an electronic wagering game table, a wagering game including a game piece;
determining, by a processor, a result for the wagering game;
receiving, by the electronic wagering game table, first player input to move the game piece to reveal the result;
presenting, on a display device, movement of the game piece;
receiving, by the electronic wagering game table, second player input to alter the movement of the game piece, wherein alteration of the movement of the game piece appears to modify the result for the wagering game; and
presenting, in response to the second player input, altered movement of the game piece and the result for the wagering game.

2. The method of claim 1, wherein the first player input is received from a first player, and wherein the second player input is received from a second player.

3. The method of claim 1, wherein the game piece is a die, and wherein the wagering game is a dice game, and wherein the second player input is a nudge of the electronic wagering game table.

4. The method of claim 1, wherein the game piece is a card, and wherein the wagering game is a card game.

5. The method of claim 1, wherein the receiving the second player input comprises:
receiving, from more than one player, game effect input to alter the movement of the game piece;
determining the second player input by aggregating the game effect input from the more than one player.

6. A method comprising:
presenting a wagering game at an electronic wagering game table;
receiving, by the electronic wagering game table, first player input for the wagering game;
determining, by a processor in response to the first player input, a result for the wagering game;
receiving, by the electronic wagering game table, second player input;
presenting, in response to the second player input, media that implies that the result for the wagering game will be altered; and
presenting media that depicts the result for the wagering game.

7. The method of claim 6, wherein the first player input is received from a first player and the second player input is received from a second player.

8. The method of claim 6, wherein the wagering game is a racing game, and wherein the media that implies that the result for the wagering game will be altered comprises a depiction of modifying the speed of one or more competitors of the racing game.

9. The method of claim 6, wherein the wagering game is a card game, and wherein the media that implies that the result for the wagering game will be altered comprises a depiction of altered dealing of cards for the card game.

10. The method of claim 6, wherein the second player input includes input from a plurality of players, and further comprising:
receiving, from each of the plurality of players, individual input;
aggregating the individual input; and
determining, based on the aggregation, the second player input.

11. An apparatus comprising:
at least one processor; and
a computer readable storage medium having computer usable code executable on the at least one processor, the computer usable program code including code to:
present, at an electronic wagering game table, a wagering game including a wagering game element;
receive, by the electronic wagering game table, first player input, wherein the first player input initiates the wagering game;
determine, by a processor, an outcome for the wagering game;
receive second player input, wherein the second player input comprises player input from one or more players, and wherein the player input from the one or more players alters movement of the wagering game element, wherein alteration of the movement of the game piece appears to influence the outcome of the wagering game;
present, in response to the second player input, the altered movement of the wagering game element; and
present the outcome for the wagering game.

12. The apparatus of claim 11, wherein the first player input is received from a first player, and wherein the second player input is received from players other than the first player.

13. The apparatus of claim 11, wherein the outcome for the wagering game is not influenced by the second player input.

14. The apparatus of claim 11, wherein the second player input from the one or more players is indicated via a button on the electronic wagering game table.

15. The apparatus of claim 11, wherein the second player input from the one or more players is determined based on one of movement of the electronic wagering game table and force exerted on the electronic wagering game table.

16. A method comprising:
receiving, by the electronic wagering game table, first player input to initiate gameplay of the wagering game;
determining, by a processor, a result of the wagering game;
presenting, on a display device of the electronic wagering game table, the gameplay of the wagering game;
receiving, by the electronic wagering game table, second player input, wherein the second player input alters the presentation of gameplay of the wagering game, and wherein the alteration of the presentation of the gameplay of the wagering game appears to modify the outcome of the wagering game;
presenting, in response to the second player input, the altered gameplay of the wagering game; and
presenting the outcome of the wagering game.

17. The method of claim 16, wherein the first player input is received from a first player, and wherein the second player input is received from one or more players, wherein the one or more players can include the first player.

18. The method of claim 16, wherein the second player input is indicated via a button on the electronic wagering game table.

19. The method of claim 16, wherein the second player input is determined based on one of movement of the electronic wagering game table and force exerted on the electronic wagering game table.

20. The method of claim 16, wherein the second player input is received from a plurality of players, and further comprising:
selecting, from the second player input from the plurality of players, the second player input from one of the plurality of players to alter the presentation of gameplay of the wagering game.

21. One or more machine-readable storage devices having instructions stored therein, which, when executed by one or more processors, causes the one or more processors to perform operations that comprise:
presenting, by an electronic wagering game table, a wagering game including a game piece;
determining, by a processor, a result for the wagering game;
receiving, by the electronic wagering game table, first player input to move the game piece to reveal the result;
presenting, on a display device, movement of the game piece;
receiving, by the electronic wagering game table, second player input to alter the movement of the game piece, wherein alteration of the movement of the game piece appears to modify the result for the wagering game; and
presenting, in response to the second player input, altered movement of the game piece and the result for the wagering game, wherein the result for the wagering game is not influenced by the second player input.

22. The one or more machine-readable storage devices of claim 21, wherein the first player input is received from a first player, and wherein the second player input is received from one or more players, wherein the one or more players can include the first player.

23. The one or more machine-readable storage devices of claim 21, wherein the second player input is indicated via a button on the electronic wagering game table.

24. The one or more machine-readable storage devices of claim 21, wherein the second player input is determined based on one of movement of the electronic wagering game table and force exerted on the electronic wagering game table.

25. The one or more machine-readable storage devices of claim 21, wherein the game piece is a card, and wherein the wagering game is a card game.
